(19) United States
(12) Patent Application Publication
(10) Pub. No.: US 2010/0083358 A1
(43) Pub. Date: Apr. 1, 2010

(54) Secure Data Aggregation While Maintaining Privacy

(75) Inventors: Velamur Rangachari Govindarajan, Bangalore (IN); Debasish Chakraborty, Bangalore (IN); Kunnath Santhosh, Bangalore (IN)

Correspondence Address: Ashok Tankha, 36 Greenleigh Drive, Sewell, NJ, 08080, US

(73) Assignee: Perfios Software Solutions Pvt. Ltd

(21) Appl. No.: 12/351,861

(22) Filed: Jan. 12, 2009

(30) Foreign Application Priority Data
Sep. 29, 2008 (IN) 2393/CHE/2008

(51) Int. Cl. H04L 9/32; G06F 21/00

(52) U.S. Cl. 726/6

(57) ABSTRACT

Disclosed herein is a computer implemented method and system that securely aggregates and manages user related data in an online environment while maintaining privacy of a user. The user provides access credentials at a client device for each of multiple data sources. The access credentials are transformed to an unreadable format at the client device using a public key transmitted by a web server. The transformed access credentials in the unreadable format are stored locally on the client device. A communicating software agent on the client device communicates the stored access credentials to the web server. The web server transforms the communicated access credentials to a readable format using a private key and retrieves the user related data by accessing the data sources using the access credentials in the readable format. The web server presents the retrieved user related data to the user in one or more presentation modes.

### CROSS REFERENCE TO RELATED APPLICATIONS

This application claims the benefit of non-provisional patent application number 2393/CHE/2008, titled “Secure Data Aggregation While Maintaining Privacy”, filed on Sep. 28, 2008 in the Indian Patent Office.

### BACKGROUND

This invention, in general, relates to data aggregation. More particularly, this invention relates to secure aggregation and management of user related data in an online environment while maintaining and not compromising privacy of a user.

People, typically, deal with different online services that provide data in their day to day life. For example, many people deal with different financial institutions every day. People typically have bank accounts, credit cards, mutual fund investments, equity holdings, loans, insurance policies, and other small scale investments. Most people manage their transactions with a financial institution manually by visiting the financial institution and performing the required transactions. However, with the advent of the internet and the availability of affordable bandwidth, online transactions with financial institutions have become more popular.

Online services provided by financial institutions typically allow their customers to access information regarding their accounts through the internet. To avail of the online services, a customer is provided with secure login credentials such as a user name and a password. The customer uses a standard web browser to access the website of the financial institution. When the customer provides the secure login credentials to the website, the customer is allowed to access their account information.

People also manage medical records online. Healthcare institutions, for example, hospitals, medical clinics, health centers, and medical professionals may provide users online access to their medical records. The healthcare institutions may provide the users secure login credentials for the users to access their medical information.

While it is possible to use a standard web browser to access account information or medical information online, there are standard techniques of accessing the online information from standard hypertext markup language (HTML) based websites in a programmatic way. These techniques, referred to as “screen scraping”, have been used for data retrieval in a variety of applications over the years since the advent of the internet.

Screen scraping has been used to facilitate an internet user to manage multiple online accesses easily. A typical internet user has multiple online accounts and needs to manage multiple user names and passwords. It may be difficult for the user to manage the user names and passwords. An internet portal employing a technique like screen scraping may be used to enable the user to manage the multiple online accounts online.

Typically, internet portals employing screen scraping to provide multiple account access to a user require the customer to share their private login credentials with the portals. There is a concern regarding security and privacy of the user when sharing the private login credentials of the user with the portal.

Hence, there is an unmet need for managing accounts at multiple data sources in an online environment and retrieving and aggregating user related data from the data sources by a web server without storing private access credentials on the server, thereby ensuring security and privacy of the user.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The computer implemented method and system disclosed herein address the above stated need for securely aggregating and managing user related data in an online environment while maintaining privacy of a user. The user registers with a secure data aggregation website hosted on a web server in the online environment. The web server generates an asymmetric key pair unique to the user. The asymmetric key pair comprises a public key and a private key. The user provides access credentials for each of multiple data sources at a client device. The web server transmits the generated public key to the client device.

The client device transforms the access credentials to an unreadable format using the transmitted public key. The transformation of the access credentials to the unreadable format may comprise encryption of the access credentials using the transmitted public key. The public key is not stored on the client device after the transformation of the access credentials to the unreadable format. The transformed access credentials in the unreadable format are stored locally on the client device.

A communicating software agent provided on the client device communicates the stored access credentials in the unreadable format to the web server. The communicating software agent may be scheduled to automatically communicate the stored access credentials to the web server at predefined intervals of time specified by the user. Alternatively, the communicating software agent may communicate the stored access credentials to the web server on receiving a command from the user at any point in time. The web server transforms the communicated access credentials from the unreadable format to a readable format. The transformation of the communicated access credentials from the unreadable format to the readable format may comprise decryption of the communicated access credentials using the generated private key stored at the web server.

The web server retrieves the user related data from the data sources using the access credentials in the readable format by accessing the data sources using the transformed access credentials in the readable format. The retrieved user related data is presented to the user in one or more presentation modes in the online environment on receiving a command from the user. The presentation modes may, for example, be one or more of summaries of the user related data, graphical representations of the user related data, user related advice based on the user related data, and notifications related to the user related data.

The retrieved user related data may be sanitized at the web server to obtain a predefined canonical format prior to the presentation to the user. The sanitization may comprise stripping the retrieved user related data of sensitive information. The sanitized user related data may be stored on the web server for retrieval at a later point in time. The web server may encrypt the sanitized user related data prior to the storage.

The web server may further perform transactions with the data sources on receiving a transaction command from the user. The web server may also notify the user if the retrieval of the user related data fails, for example, due to incorrect access credentials, changes made to the data sources, etc.

Hence, the transformation of the access credentials to the unreadable format and local storage of the access credentials on the client device enhances security and privacy of the user related data during the aggregation and the management of the user related data.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a computer implemented method of securely aggregating and managing user related data in an online environment while maintaining privacy of a user.

FIG. 2 illustrates a computer implemented system for securely aggregating and managing user related data in an online environment while maintaining privacy of a user.

FIG. 3 exemplarily illustrates a webpage provided by the secure data aggregation website for registration of a user.

FIG. 4 exemplarily illustrates a login screen provided by the secure data aggregation website for logging in a registered user.

FIG. 5 exemplarily illustrates a webpage provided by the secure data aggregation website for enabling a user to provide access credentials for a savings account maintained at a banking financial institution.

FIG. 6 exemplarily illustrates a webpage provided by the secure data aggregation website for enabling a user to provide access credentials for a credit card account maintained at a credit card financial institution.

FIG. 7 exemplarily illustrates a webpage provided by the secure data aggregation website for enabling a user to store the communicating software agent on the client device.

FIG. 8 exemplarily illustrates location of storage of the transformed access credentials in the folder hierarchy of the client device.

FIG. 9 exemplarily illustrates the transformed access credentials stored in the unreadable format on the client device.

FIG. 10 exemplarily illustrates a webpage provided by the secure data aggregation website for providing profile information by a user.

FIG. 11 exemplarily illustrates a notification provided to the user by the secure data aggregation website during the retrieval of the financial data.

FIGS. 12A-12B exemplarily illustrate split views of presentation of the retrieved financial data to the user in a dashboard view.

FIGS. 13A-13B exemplarily illustrate split views of presentation of the retrieved financial data to the user in a summary view.

FIG. 14 exemplarily illustrates a webpage provided by the secure data aggregation website for selecting a category of a transaction by a user.

FIG. 15 exemplarily illustrates a webpage provided by the secure data aggregation website for importing financial data from a spreadsheet processing software program by the user.

FIG. 16 exemplarily illustrates a webpage for defining events on occurrence of which notifications are provided by the secure data aggregation website.

### DETAILED DESCRIPTION OF THE INVENTION

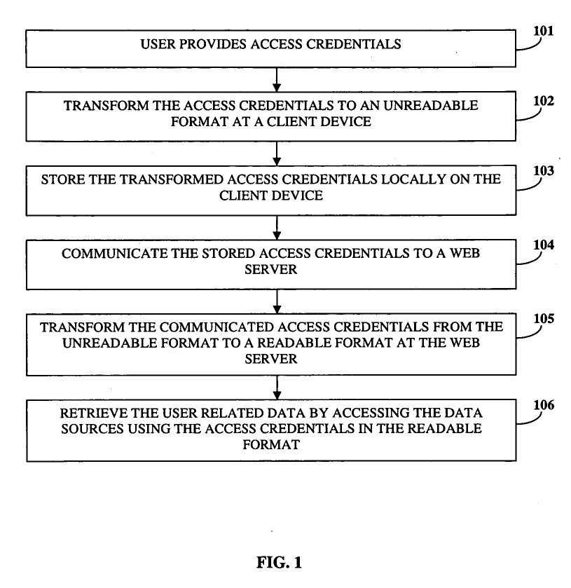

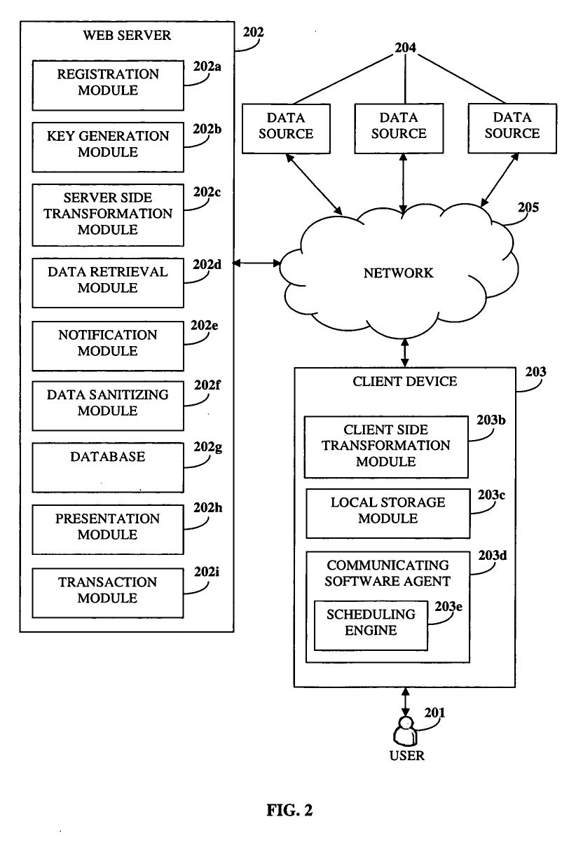

FIG. 1 illustrates a computer implemented method of securely aggregating and managing user related data in an online environment while maintaining privacy of a user 201. The online environment comprises multiple data sources 204, a client device 203, and a secure data aggregation website hosted on a web server 202 connected via a network 205 as illustrated in FIG. 2. The network 205 may, for example, be the internet. The client device 203 may, for example, be a personal computer, a handheld computing device, a mobile phone, etc. The user 201 registers with the secure data aggregation website in the online environment. The web server 202 generates an asymmetric key pair unique to the user 201. The asymmetric key pair comprises a public key and a private key. The user 201 provides 101 access credentials for each of multiple data sources 204 at the client device 203. The data sources 204 may be internet sites, for example, websites of financial institutions such as banks, credit unions, stock brokerages, asset management firms, etc. The data sources 204 may also be websites of healthcare institutions, for example, hospitals, medical clinics, health centers, and medical professionals.

The access credentials may comprise user names, passwords, digital signatures, authentication certificates, etc that uniquely identify and authenticate the user 201 to the data sources 204. The access credentials may have been previously obtained by the user 201 from the data sources 204 for accessing the data sources 204.

The web server 202 transmits the generated public key to the client device 203. The access credentials are transformed 102 at the client device 203 to an unreadable format using the transmitted public key. The transformation of the access credentials to the unreadable format may comprise encryption of the access credentials using the transmitted public key. The public key is not stored on the client device 203 after the transformation of the access credentials to the unreadable format.

The client device 203 locally stores 103 the transformed access credentials. No part of the transformed access credentials is stored on the web server 202. The transformed access credentials are stored only on the client device 203 and the public key and the private key are stored on the web server 202, thereby ensuring security and privacy of the access credentials.

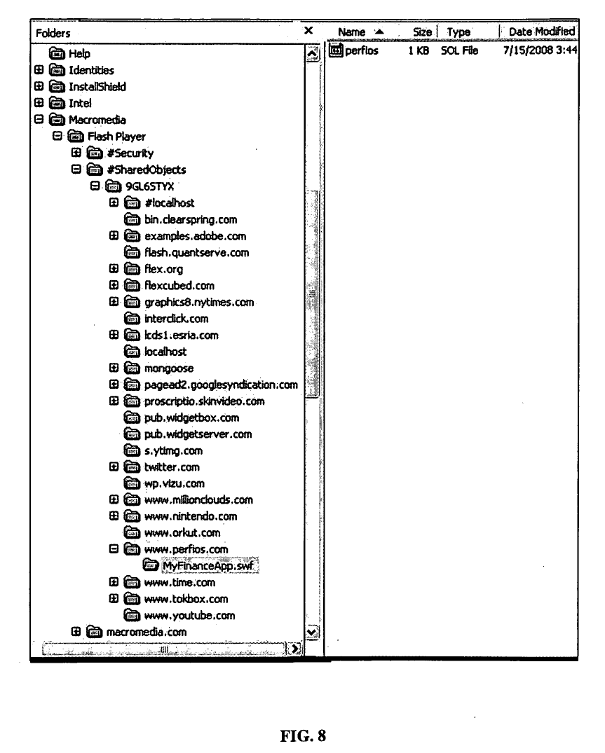

The transformed access credentials are stored within the folder hierarchy of the client device 203 to prevent unauthorized access of the access credentials, as illustrated in FIG. 8. Furthermore, the transformed access credentials may be stored in a proprietary or semi proprietary file format, for example, a flash local shared object (LSO) file typically with an SOL extension. If an unauthorized user accesses the client device 203 and locates the transformed access credentials, the encrypted access credentials will be unreadable to the unauthorized user, as the private key for decrypting the transformed user credentials is stored on the web server 202. Similarly, if an authorized user accesses the web server 202 and retrieves the private key, the unauthorized user will not have access to the transformed access credentials in the unreadable format to decrypt with the private key, as the transformed access credentials are stored on the client device 203.

A communicating software agent 203d is provided on the client device 203. The user 201 may download and install the communicating software agent 203d on the client device 203 from the secure data aggregation website. The communicating software agent 203d may be installed as an operating system service or a background daemon process on the client device 203. The communicating software agent 203d launches automatically on startup of the operating system of the client device 203 and runs as a background process. The communicating software agent 203d communicates 104 the stored access credentials from the client device 203 to the web server 202. The communicating software agent 203d may package the stored access credentials on the client device 203 prior to communicating to the web server 202. The user 201 may configure schedules for the communicating software agent 203d to automatically communicate the stored access credentials to the web server 202 at predefined intervals of time specified by the user 201. For example, the user 201 may configure the communicating software agent 203d to communicate with the web server 202 on an hourly, daily, or weekly basis. Alternatively, the user 201 may bypass the communicating software agent 203d by remotely logging in to the web server 202 manually from the client device 203 and providing the stored access credentials to the web server 202. The communicating software agent 203d goes into an inactive sleep mode after communicating with the web server 202 and runs in the inactive sleep mode till the next scheduled communication with the web server 202.

The web server 202 transforms 105 the communicated access credentials from the unreadable format to a readable format. The web server 202 may transform the communicated access credentials to the readable format by decrypting the communicated access credentials using the generated private key stored on the web server 202. The web server 202 retrieves 106 the user related data from the data sources 204 by accessing the data sources 204 using the access credentials in the readable format. The web server 202 may retrieve only subsets of the user related data, if the user 201 has previously defined the subsets of the user related data to be retrieved. For example, the user 201 may instruct the web server 202 to retrieve the user related data only from a particular data source, or the user related data only within a particular range of dates.

The web server 202 accesses the data sources 204 using a secure connection, for example, as hypertext transfer protocol over secure socket layer (HTTPS). The web server 202 retrieves the user related data using screen scraping. Screen scraping is a technique in which a computer program extracts data from the display output of another program or a web page. Screen scraping may be used as a data extracting and data harvesting tool. The retrieved user related data typically comprises hypertext markup language (HTML) content. However, the retrieved user data may also be in a different format, for example, an extensible markup language (XML) format or a quicken interchange format (QIF), etc.

The web server 202 may sanitize the retrieved user related data to obtain a canonical format predefined by the web server 202. The sanitization comprises stripping the retrieved user related data of sensitive information. The sensitive information may, for example, comprise name of the user 201, address of the user 201, account number of the user 201, etc. The web server 202 may store the sanitized user related data in its canonical format for retrieval at a later point in time. The web server 202 may encrypt the sanitized user related data prior to storage to enhance security of the sanitized user related data.

The web server 202 presents the retrieved user related data to the user 201 in one or more presentation modes in the online environment on receiving a command from the user 201. The presentation modes may, for example, be one or more of summaries of the user related data, graphical representations of the user related data, advice based on the user related data, and notifications related to the user related data. For example, if the data sources 204 are financial institutions, the user related data may be financial data of the user 201. The financial data may, for example, be bank statements, credit card statements, investment returns data, etc. The retrieved financial data may then be presented to the user 201 in the form of a summary of assets and liabilities of the user 201, pie charts and bar graphs representative of the spending trends of the user 201, or investment and tax advice based on the financial data of the user 201. The user 201 may also receive notifications on occurrence of predefined events, for example, withdrawal of large sums of money from an account of the user 201 with the financial institution.

The web server 202 may further perform transactions with the data sources 204 in the online environment on receiving a transaction command from the user 201. For example, the web server 202 may transfer funds from one bank account to another, forward the user's 201 medical records to a doctor, etc. The web server 202 may also notify the user 201 if the retrieval of the user related data fails. The retrieval of the user related data may fail if the access credentials provided are incorrect. The web server 202 will not attempt to retrieve the user related data from the data sources 204 for which the access credentials provided are incorrect. The web server 202 notifies the user 201 of the failure of the retrieval of the user related data due to incorrect user credentials. The web server 202 only attempts to retrieve the user related data after the user 201 modifies the incorrect access credentials provided for the data sources 204.

The retrieval of the user related data may also fail if modifications are made to the data sources 204, for example, if the layout of a website of a financial institution is modified. In this case, the screen scraping performed by the web server 202 may fail. The web server 202 notifies the user 201 of the failure of the retrieval of the user related data due to failure of screen scraping. The web server 202 will not attempt to retrieve the user related data from the data sources 204 for which the screen scraping fails. The web server 202 also notifies an administrator of the secure data aggregation website. The administrator of the secure data aggregation website may modify routines used for the screen scraping. The web server 202 only attempts to retrieve the user related data after the administrator modifies the routines used for the screen scraping.

The steps involved in the method disclosed herein may or may not be contiguous events. After the registration of the user 201 and the generation of the asymmetric key pair, a period of time, for example a month, may lapse before the next step of providing the access credentials by the user 201. Similarly, the communicating software agent 203d may communicate the access credentials to the web server 202 and the web server 202 may retrieve the user related data on a daily or weekly basis, as specified by the user 201. However, the retrieved user related data may be presented to the user 201 only when the user 201 accesses the secure data aggregation website. For example, the user 201 may not access the secure data aggregation website three months after providing the access credentials, in which case the web server 202 will present the user 201 the user related data aggregated over the three months.

FIG. 2 illustrates a computer implemented system for securely aggregating and managing user related data in an online environment while maintaining privacy of a user 201. The system disclosed herein comprises a client device 203 and a web server 202. The client device 203 comprises a client side transformation module 203b, a local storage module 203c, and a communicating software agent 203d. The web server 202 comprises a registration module 202a, a key generation module 202b, a server side transformation module 202c, a data retrieval module 202d, a notification module 202e, a data sanitizing module 202f, a database 202g, a presentation module 202h, and a transaction module 202i. The web server 202 and the client device 203 are connected to each other and to the data sources 204 via a network 205.

The registration module 202a registers the user 201 with the secure data aggregation website hosted on the web server 202 in the online environment. The key generation module 202b generates an asymmetric key pair unique to the user 201. The asymmetric key pair comprises a public key and a private key. The user 201 provides the access credentials at the client device 203 for each of multiple data sources 204 in the online environment. The web server 202 transmits the public key to the client device 203. The client side transformation module 203b transforms the access credentials to an unreadable format using the transmitted public key. The client side transformation module 203b may transform the access credentials to the unreadable format by encrypting the access credentials using the transmitted public key. The local storage module 203c stores the transformed access credentials in the unreadable format locally on the client device 203.

The communicating software agent 203d provided on the client device 203 communicates the stored access credentials to the web server 202. The communicating software agent 203d comprises a scheduling engine 203e. The scheduling engine 203e schedules the communicating software agent 203d to automatically communicate the stored access credentials to the web server 202 at predefined intervals of time specified by the user 201. The communicating software agent 203d may also communicate the stored access credentials to the web server 202 on receiving a command from the user 201 at any point in time.

The server side transformation module 202c in the web server 202 transforms the communicated access credentials from the unreadable format to a readable format using the generated private key. The server side transformation module 202c may transform the access credentials to the readable format by decrypting the access credentials using the generated private key stored on the web server 202. The data retrieval module 202d retrieves the user related data from the data sources 204 by accessing the data sources 204 using the access credentials in the readable format. The data retrieval module 202d accesses the data sources 204 using a secure connection such as hypertext transfer protocol over secure socket layer (HTTPS). The data retrieval module 202d retrieves the user related data from the data sources 204 using screen scraping.

The data sanitizing module 202f sanitizes the retrieved user related data to obtain a predefined canonical format. The data sanitizing module 202f strips the retrieved user related data of sensitive information. The sensitive information may, for example, comprise name of the user 201, address of the user 201, account number of the user 201, etc. The database 202g stores the retrieved user related data in the canonical format for retrieval at a later point in time. The server side transformation module 202c may encrypt the retrieved user related data prior to the storage. The presentation module 202h presents the retrieved user related data to the client device 203 in multiple presentation modes. The presentation modes may, for example, be summaries of the user related data, graphical representations of the user related data, advice based on the user related data, and notifications related to the user related data.

The transaction module 202i performs transactions with the data sources 204 in the online environment on receiving a transaction command from the user 201. The transaction module 202i may, for example, perform transfer of funds from one bank account to another, or forwarding the user's 201 medical records to a doctor on behalf of the user 201. The notification module 202e notifies the user 201 if the retrieval of the user related data fails due to retrieval errors. The retrieval of the user related data may fail if the access credentials provided are incorrect, or if modifications are made to the data sources 204. The data retrieval module 202d will not attempt to retrieve the user related data from the data sources 204 for which the retrieval fails until the retrieval errors are corrected. The notification module 202e may further notify the user 201 on occurrence of predefined events, for example, withdrawal of large sums of money from an account of the user 201 with the financial institution. The user 201 may configure the notification module 202e to define the events.

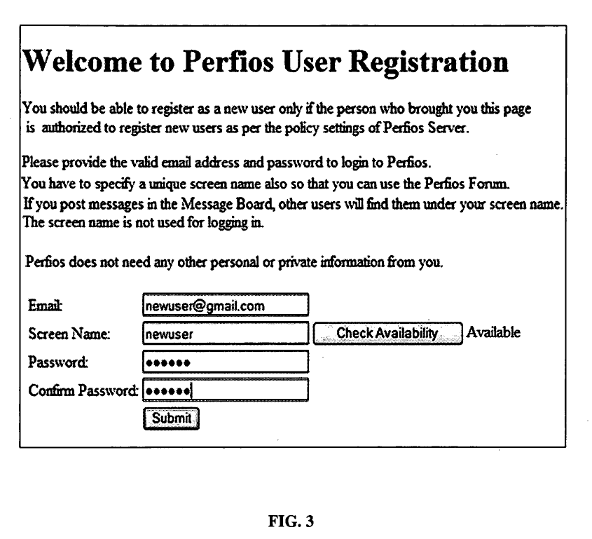

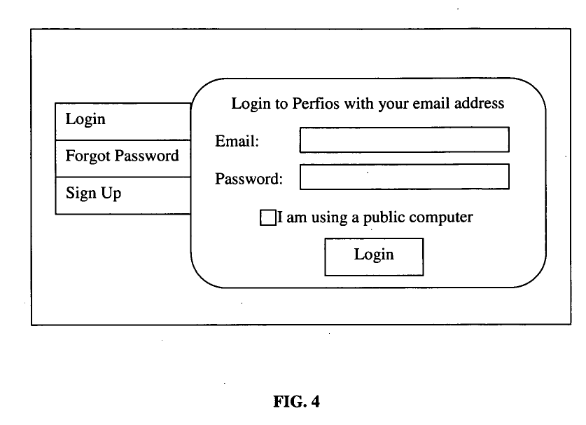

Consider an example where a user 201 needs secure aggregation of financial data from multiple financial institutions while maintaining privacy. The user 201 maintains multiple bank accounts and credit card accounts at the financial institutions. The user related data is financial data and the data sources 204 are the financial institutions. The user 201 registers with the secure data aggregation website in the online environment. A webpage provided by the secure data aggregation website for registration of a user 201 is exemplarily illustrated in FIG. 3. The secure data aggregation website is hosted on the web server 202. The user 201 is asked to provide a user name and a password for authenticating the user 201 to the secure data aggregation website. The user 201 may also be asked to enter a screen name. The user 201 is not required to enter the user's 201 true name. During registration, an asymmetric key pair comprising a public key and a private key is generated and stored on the web server 202. The asymmetric key pair is unique to the user 201. A registered user may login to the secure data aggregation website using a login screen provided by the secure data aggregation website, as exemplarily illustrated in FIG. 4.

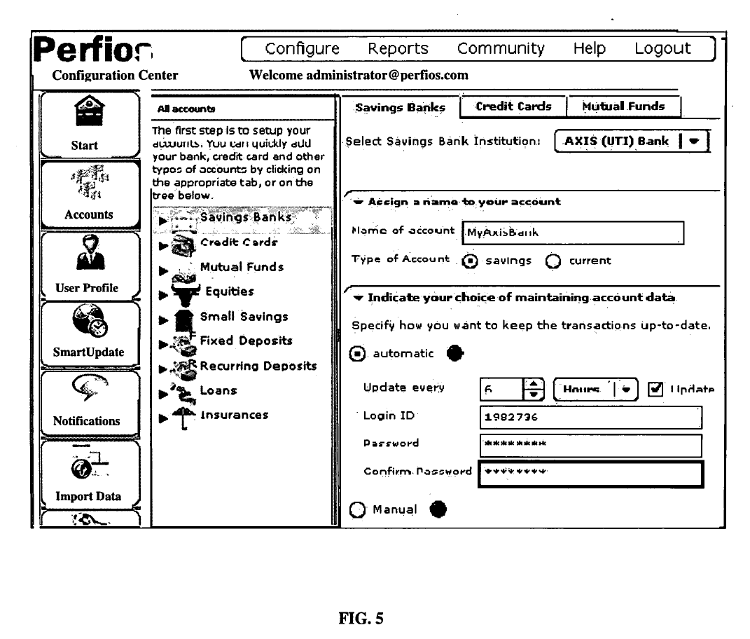

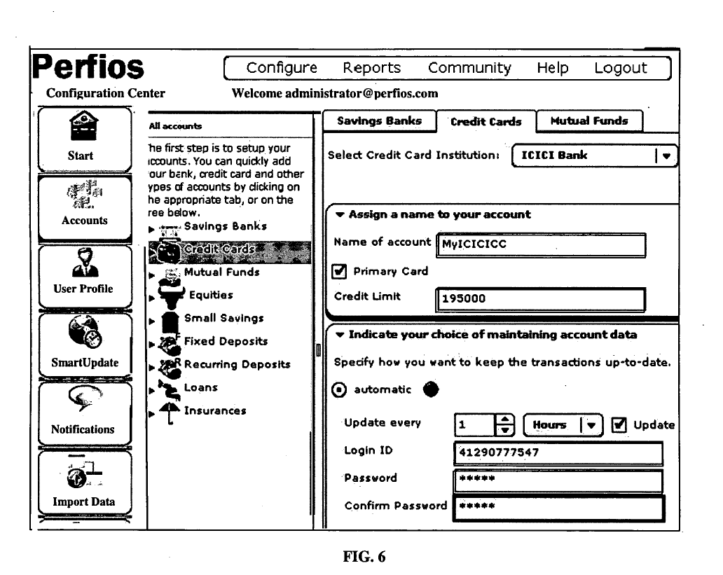

FIG. 5 exemplarily illustrates a webpage provided by the secure data aggregation website for enabling the user 201 to provide access credentials for a savings account maintained at a banking financial institution. The user 201 selects the banking financial institution from a drop down list and provides authentication information for the banking financial institution using a text entry form. The authentication information may comprise a user name and a password. A web page provided by the secure data aggregation website for enabling the user 201 to provide access credentials for a credit card account maintained at a credit card financial institution is exemplarily illustrated in FIG. 6. The user 201 selects the credit card financial institution from a drop down list and provides authentication information for the credit card financial institution using a text entry form. The web server 202 transmits the generated public key to the client device 203. The access credentials provided by the user 201 are encrypted using the transmitted public key and stored locally on the client device 203.

The secure data aggregation website also provides the user 201 a choice between automatic retrieval and manual update. If the user 201 chooses automatic retrieval, the financial data is retrieved by the secure data aggregation website automatically at intervals of time specified by the user 201. If the user 201 chooses manual update, the user 201 must manually provide the financial data to be stored on the web server 202. The manual update may also allow the user 201 to upload financial data from a spreadsheet, for example, Microsoft® Excel. If the user 201 chooses manual update, providing the access credentials is not required. If the access credentials are provided, the access credentials are transformed to an unreadable format and stored on the client device 203 of the user 201.

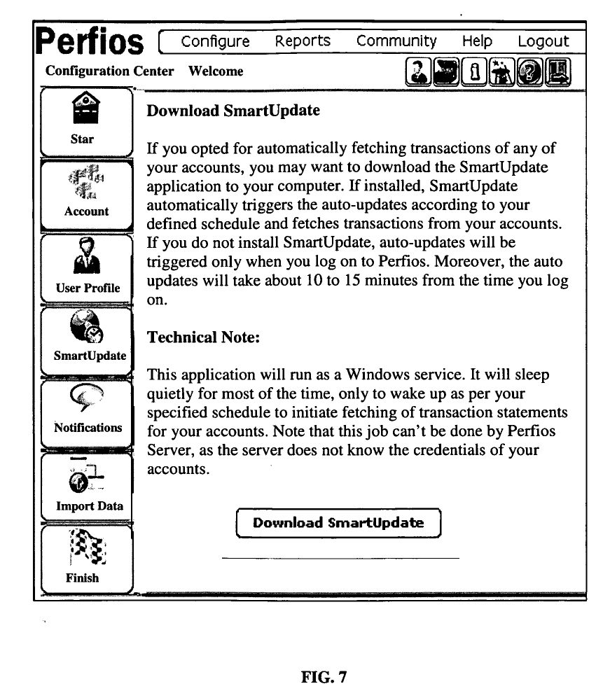

FIG. 7 exemplarily illustrates a web page provided by the secure data aggregation website for enabling the user 201 to store the communicating software agent 203d on the client device 203. The user 201 may download the communicating software agent 203d on the client device 203. In FIG. 7, the communicating software agent 203d is referred to as “SmartUpdate”. The communicating software agent 203d communicates the stored access credentials to the web server 202. Storing the communicating software agent 203d is not required if the user 201 chooses manual update of the financial data. The communicating software agent 203d runs as a software process in the background on the client device 203.

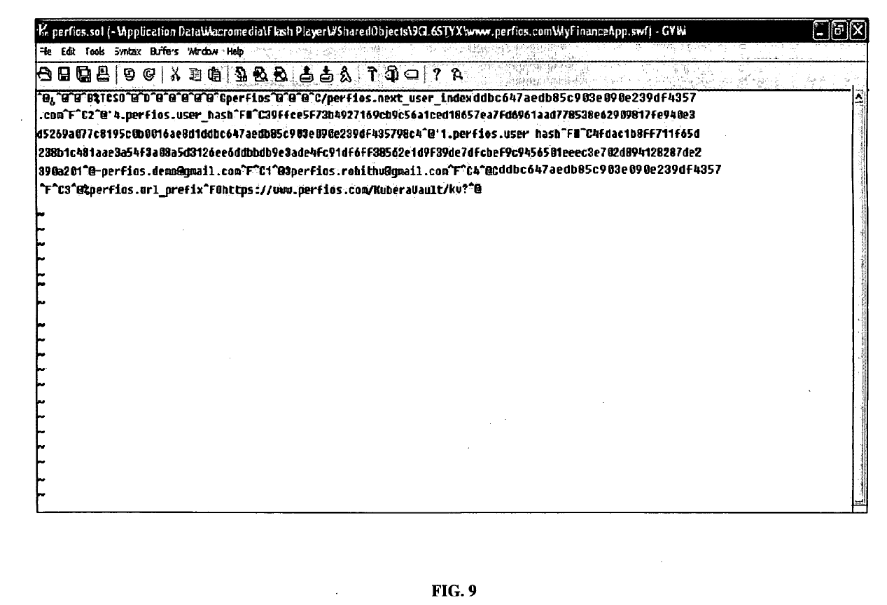

FIG. 8 exemplarily illustrates the location of storage of the transformed access credentials in the folder hierarchy of the client device 203. The storage of the transformed access credentials deep in the folder hierarchy of the client device 203 prevents unauthorized locating and accessing of the access credentials. In FIG. 8, the transformed access credentials are stored in a file named “perfios.sol” within the folder named “MyFinanceApp.swf”. The transformed access credentials stored in the unreadable format on the client device 203 stored in the file named “perfios.sol” is exemplarily illustrated in FIG. 9.

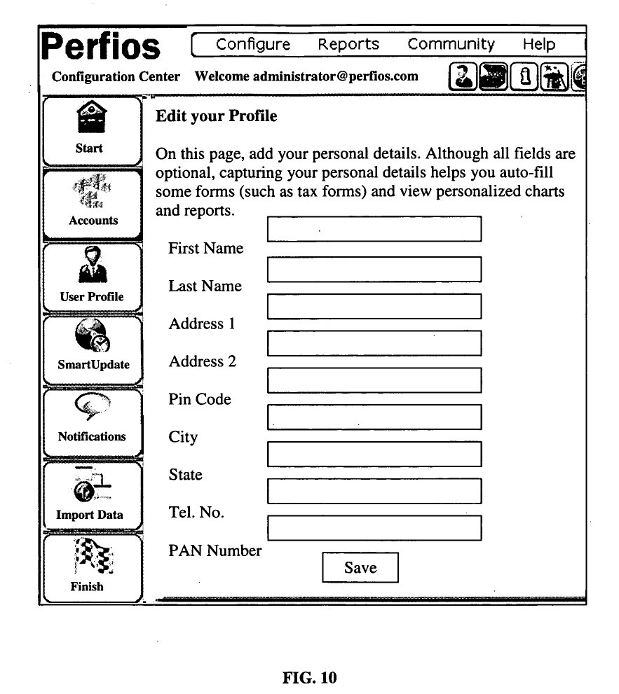

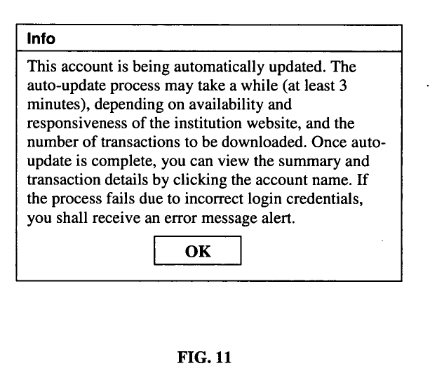

FIG. 10 exemplarily illustrates a webpage provided by the secure data aggregation website for providing profile information by the user 201. The profile information may, for example, comprise name, street address, postal code, city, state, telephone number, etc. Providing the profile information by the user 201 is optional. The profile information may be used by the secure data aggregation website for auto filling forms, for example, tax forms. The secure data aggregation website does not use the profile information for retrieving the financial data. A notification provided to the user 201 by the secure data aggregation website during the retrieval of the financial data is exemplarily illustrated in FIG. 11.

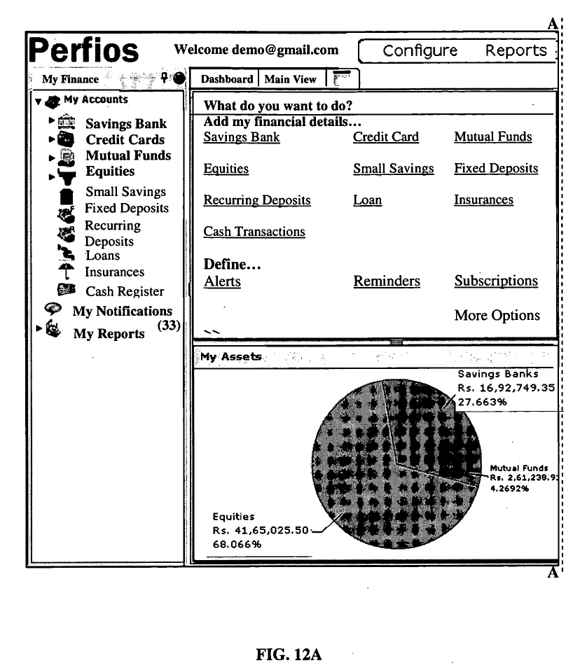

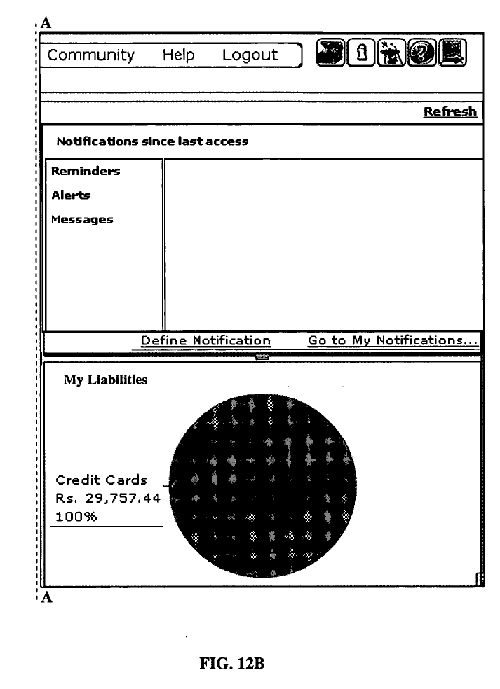

FIGS. 12A-12B exemplarily illustrate split views of presentation of the retrieved financial data to the user 201 in a dashboard view. The split views FIG. 12A and FIG. 12B may be assembled along an axis AA to obtain a complete dashboard view. The dashboard view presents the retrieved financial data to the user 201 in an easily understandable format, for example, as pie charts. The dashboard view may display notifications and asset and liability summaries. Further, the dashboard view provides direct links to other views and functions of the secure data aggregation website such as adding accounts, modifying accounts, and managing notifications.

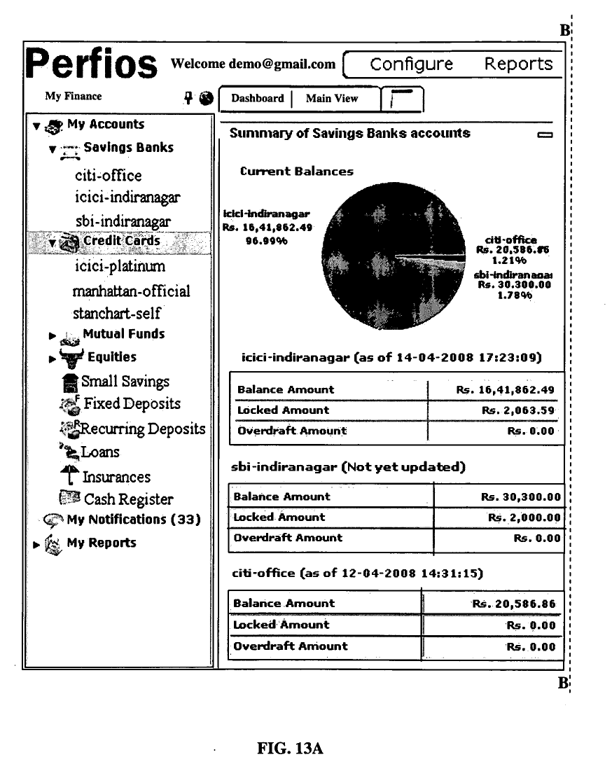

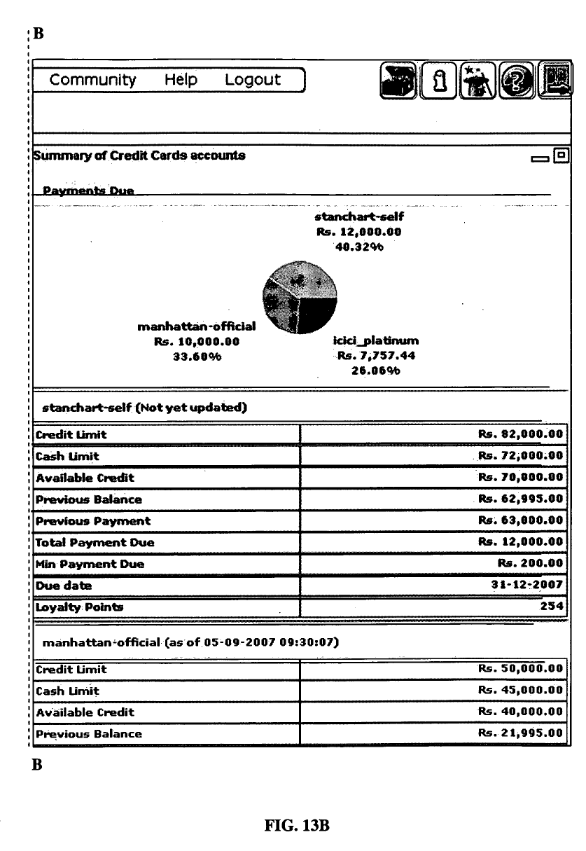

FIGS. 13A-13B exemplarily illustrate split views of presentation of the retrieved financial data to the user 201 in a summary view. The split views FIG. 13A and FIG. 13B may be assembled along an axis BB to obtain a complete summary view. The summary view provides summaries of the user's 201 accounts at the financial institutions. The presentation of the summaries may comprise pie charts and tables for each account maintained at each of the financial institutions.

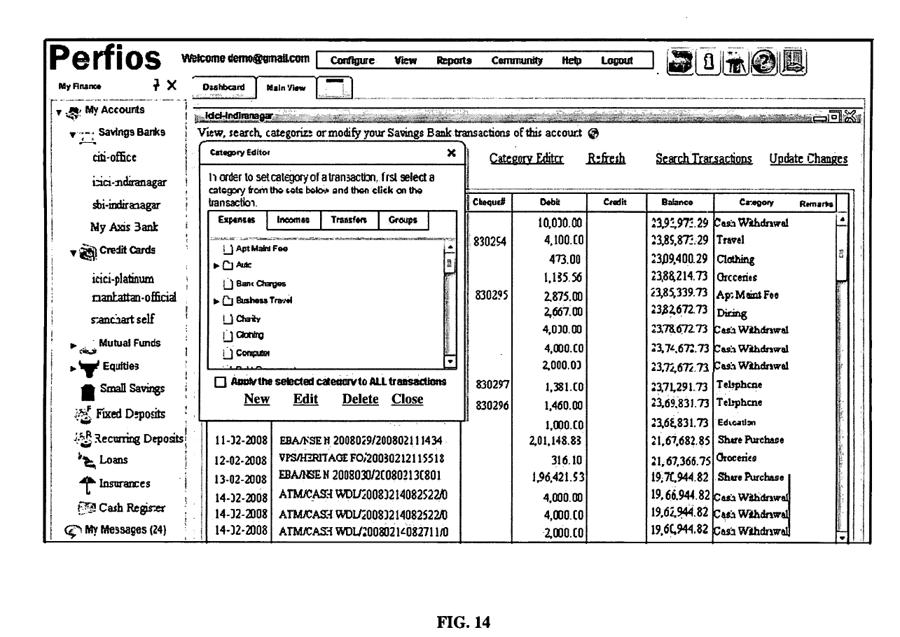

The retrieved financial data may also be presented to the user 201 in additional presentation modes. For example, the secure data aggregation website may calculate the user's 201 tax returns based on the retrieved financial data. The secure data aggregation website may also provide the user 201 with an option for filing the tax returns online through the secure data aggregation website. Furthermore, the user 201 may manually enter financial transactions in the secure data aggregation website. The entered transactions may be categorized into different types, for example business travel, clothing, education, etc. A webpage provided by the secure data aggregation website for selecting a category of a transaction by the user 201 is exemplarily illustrated in FIG. 14.

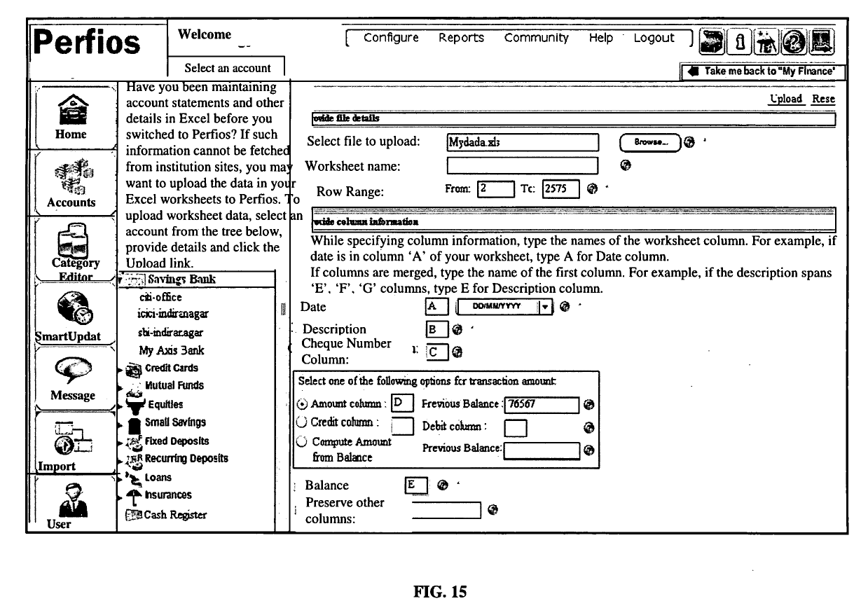

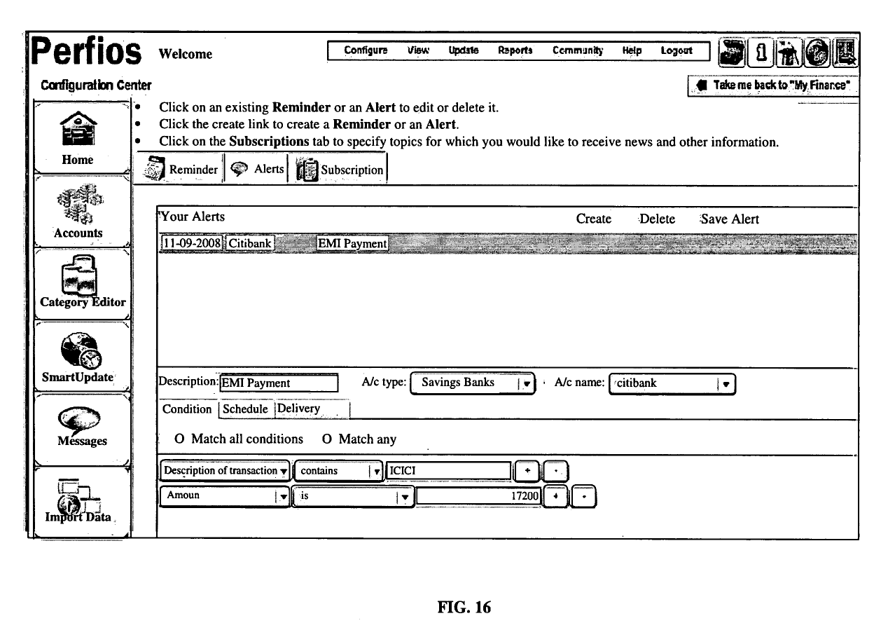

The user 201 may import or export financial data from or to a software program, for example, a spreadsheet processing software program, on the client device 203. A webpage provided by the secure data aggregation website for importing financial data from a spreadsheet processing software program by the user 201 is exemplarily illustrated in FIG. 15. In FIG. 15, the financial data is imported from Microsoft® Excel. Further, the user 201 may also define events on occurrence of which notifications are provided to the user 201 by the secure data aggregation website. A webpage provided by the secure data aggregation website for defining events on occurrence of which notifications are provided to the user 201 is exemplarily illustrated in FIG. 16. The user 201 may also configure notification conditions and mode of notifications, for example, the user 201 may configure the secure data aggregation website to notify the user 201 via an electronic mail (email) message every time the financial data is retrieved.

The secure data aggregation website may provide the user 201 summarized graphical representations of the classified financial transactions based on the classification. Furthermore, the secure data aggregation website may provide the user 201 with financial advice based on the classification. For example, if the user 201 wants to limit monthly leisure expenses, the secure data aggregation website may calculate an optimal financial strategy to meet the financial goals of the user 201.

Consider a second example where a user 201 avails of medical facilities at multiple healthcare institutions, for example, a cardiac clinic, a general hospital, a diagnostic center, and a pharmacy. Each of the healthcare institutions maintains medical data of the user 201. The medical data comprises case histories, prescriptions, diagnostic reports, and test results, which the user 201 would not like to share with unauthorized persons. The user 201 needs to securely aggregate the medical data from all the healthcare institutions, while maintaining privacy.

The user 201 registers with the secure data aggregation website hosted on the web server 202. The web server 202 generates an asymmetric key pair unique to the user 201. The asymmetric key pair comprises a public key and a private key. The user 201 provides access credentials for each of the healthcare institutions at a client device 203. The web server 202 transmits the generated public key to the client device 203. The client device 203 encrypts the access credentials using the transmitted public key and locally stores the encrypted access credentials. The transmitted public key is not stored on the client device 203. The user 201 downloads the communicating software agent 203d to the client device 203 from the secure data aggregation website. The communicating software agent 203d is installed as an operating system service on the client device 203. The user 201 may configure the communicating software agent 203d to automatically retrieve the medical data at a predefined point in time. In this example, the user 201 configures the communicating software agent 203d to automatically retrieve the medical data from the healthcare institutions at 10:00 am every Monday.

The communicating software agent 203d runs in sleep mode till 10:00 am the next Monday. At 10:00 am the next Monday, the communicating software agent 203d communicates the encrypted access credentials to the web server 202. The web server 202 decrypts the communicated access credentials using the generated private key. The web server 202 retrieves the medical data by accessing the healthcare institutions using the decrypted access credentials. The web server 202 sanitizes the retrieved medical data by removing sensitive information, for example, name, contact details, and personal details of the user 201 from the retrieved medical data. The web server 202 stores the sanitized medical data.

The user 201 accesses the secure data aggregation website via the client device 203. The web server 202 presents the stored medical data to the user 201. The web server 202 may present the stored medical data to the user 201 in a summary view, in a detailed view, or as a downloadable file. The web server 202 may also provide additional information to the user 201. For example, the web server 202 may provide information about illnesses referred to in the medical data, or information about interactions between drugs in the prescriptions. Furthermore, the web server 202 may provide the user 201 a list of doctors, hospitals, and pharmacies in a particular city. The web server 202 may also enable the user 201 to order medication from online pharmacies using the prescriptions, and to forward the medical data to a healthcare institution. The web server 202 may further manage the user's 201 health insurance information and provide the user 201 health insurance advice and online health insurance claims processing services.

It will be readily apparent that the various methods and algorithms described herein may be implemented in a computer readable medium appropriately programmed for general purpose computers and computing devices. Typically a processor, for e.g., one or more microprocessors will receive instructions from a memory or like device, and execute those instructions, thereby performing one or more processes defined by those instructions. Further, programs that implement such methods and algorithms may be stored and transmitted using a variety of media, for e.g., computer readable media in a number of manners. In one embodiment, hard-wired circuitry or custom hardware may be used in place of, or in combination with, software instructions for implementation of the processes of various embodiments. Thus, embodiments are not limited to any specific combination of hardware and software. A “processor” means any one or more microprocessors, Central Processing Unit (CPU) devices, computing devices, microcontrollers, digital signal processors or like devices. The term “computer-readable medium” refers to any medium that participates in providing data, for example instructions that may be read by a computer, a processor or a like device. Such a medium may take many forms, including but not limited to, non-volatile media, volatile media, and transmission media. Non-volatile media include, for example, optical or magnetic disks and other persistent memory volatile media include Dynamic Random Access Memory (DRAM), which typically constitutes the main memory. Transmission media include coaxial cables, copper wire and fiber optics, including the wires that comprise a system bus coupled to the processor. Common forms of computer-readable media include, for example, a floppy disk, a flexible disk, hard disk, magnetic tape, any other magnetic medium, a Compact Disc-Read Only Memory (CD-ROM), Digital Versatile Disc (DVD), any other optical medium, punch cards, paper tape, any other physical medium with patterns of holes, a Random Access Memory (RAM), a Programmable Read Only Memory (PROM), an Erasable Programmable Read Only Memory (EPROM), an Electrically Erasable Programmable Read Only Memory (EEPROM), a flash memory, any other memory chip or cartridge, a carrier wave as described hereinafter, or any other medium from which a computer can read. In general, the computer-readable programs may be implemented in any programming language. Some examples of languages that can be used include C, C++, C#, or JAVA. The software programs may be stored on or in one or more mediums as an object code. A computer program product comprising computer executable instructions embodied in a computer-readable medium comprises computer parsable codes for the implementation of the processes of various embodiments.

Where databases are described such as the database 202g, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats including relational databases, object-based models and/or distributed databases could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, Local Area Network (LAN), Wide Area Network (WAN) or Ethernet, Token Ring, or via any appropriate communications means or combination of communications means. Each of the devices may comprise computers, such as those based on the Intel® processors, AMD® processors, Sun® processors, IBM® processors etc., that are adapted to communicate with the computer. Any number and type of machines may be in communication with the computer.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

We claim:

1. A computer implemented method of securely aggregating and managing user related data in an online environment while maintaining privacy of a user, comprising the steps of:
providing access credentials at a client device for each of a plurality of data sources by said user;
transforming said access credentials to an unreadable format at said client device using a public key transmitted by a web server;
storing said transformed access credentials in said unreadable format locally on the client device;
communicating said stored access credentials to said web server by a communicating software agent provided on the client device;
transforming said communicated access credentials from the unreadable format to a readable format at the web server using a private key generated in the web server; and
retrieving said user related data from said data sources by the web server by accessing the data sources using the access credentials in said readable format;
whereby said transformation of the access credentials to the unreadable format and local storage of the access credentials on the client device enhances security and privacy of the user related data during said aggregation and said management of the user related data in said online environment.

2. The computer implemented method of claim 1, further comprising the step of presenting said retrieved user related data to the user in one or more of a plurality of presentation modes in the online environment on receiving a command from the user.

3. The computer implemented method of claim 2, wherein said one or more presentation modes are one or more of summaries of the user related data, graphical representations of the user related data, user related advice based on the user related data, and notifications related to the user related data.

4. The computer implemented method of claim 1, further comprising the step of registering the user in the online environment, wherein the user provides the access credentials after said registration.

5. The computer implemented method of claim 1, further comprising the step of generating an asymmetric key pair unique to the user by the web server prior to said provision of the access credentials by the user, wherein said asymmetric key pair comprises said public key and said private key.

6. The computer implemented method of claim 1, wherein the transformation of the access credentials to the unreadable format comprises encryption of the access credentials using said transmitted public key.

7. The computer implemented method of claim 1, wherein said transformation of the communicated access credentials from the unreadable format to the readable format comprises decryption of the communicated access credentials using said generated private key.

8. The computer implemented method of claim 1, further comprising the step of sanitizing said retrieved user related data to obtain a predefined canonical format and storing the retrieved user related data on the web server, wherein said sanitization comprises stripping the retrieved user related data of sensitive information.

9. The computer implemented method of claim 8, further comprising the step of encrypting said sanitized user related data prior to said storage.

10. The computer implemented method of claim 1, further comprising the step of scheduling automatic communication of the stored access credentials to the web server at predefined intervals of time specified by the user using said communicating software agent on the client device.

11. The computer implemented method of claim 1, further comprising the step of performing transactions with the data sources in the online environment on receiving a transaction command from the user.

12. The computer implemented method of claim 1, further comprising a step of notifying the user if said retrieval of the user related data fails.

13. A computer implemented method of securely aggregating and managing user related data in an online environment while maintaining privacy of a user, comprising the steps of:
generating an asymmetric key pair unique to said user by a web server, wherein said asymmetric key pair comprises a public key and a private key;
providing access credentials at a client device for each of a plurality of data sources by the user;
encrypting said access credentials at said client device using said public key transmitted by said web server;
storing said encrypted access credentials locally on the client device;
communicating said stored access credentials to the web server by a communicating software agent provided on the client device;
decrypting said communicated access credentials at the web server using said private key generated by the web server; and
retrieving said user related data from said data sources by the web server by accessing the data sources using said decrypted access credentials;
whereby said encryption and local storage of the access credentials on the client device enhances security and privacy of the user related data during said aggregation and said management of the user related data in said online environment.

14. A computer implemented system for securely aggregating and managing user related data in an online environment while maintaining privacy of a user, comprising:
a client device comprising:
a client side transformation module for transforming access credentials provided by said user to an unreadable format using a public key transmitted by a web server;
a local storage module for locally storing said transformed access credentials in said unreadable format; and
a communicating software agent for communicating said stored access credentials to said web server;
the web server comprising:
a server side transformation module for transforming said communicated access credentials from the unreadable format to a readable format using a private key; and
a data retrieval module for retrieving said user related data from said data sources by accessing the data sources using the access credentials in said readable format.

15. The computer implemented system of claim 14, wherein said web server further comprises a registration module for registering the user in said online environment.

16. The computer implemented system of claim 14, wherein said web server further comprises a key generation module for generating an asymmetric key pair unique to the user, wherein said asymmetric key pair comprises said public key and said private key.

17. The computer implemented system of claim 14, wherein said client side transformation module transforms the access credentials to the unreadable format by encrypting the access credentials using said transmitted public key.

18. The computer implemented system of claim 14, wherein said server side transformation module transforms the access credentials to the readable format by decrypting the access credentials using said private key.

19. The computer implemented system of claim 14, wherein said communicating software agent comprises a scheduling engine for scheduling automatic communication of the stored access credentials to the web server at predefined intervals of time specified by the user.

20. The computer implemented system of claim 14, wherein said web server further comprises a presentation module for presenting said retrieved user related data to the user in one or more of a plurality of presentation modes in said online environment on receiving a command from the user, wherein said one or more presentation modes are one or more of summaries of the user related data, graphical representations of the user related data, user related advice based on the user related data, and notifications related to the user related data.

21. The computer implemented system of claim 14, wherein said web server further comprises a data sanitization module for sanitizing the retrieved user related data to obtain a predefined canonical format, wherein said data sanitization module strips the retrieved user related data of sensitive information.

22. The computer implemented system of claim 14, wherein said web server further comprises a database for storing the retrieved user related data and sanitized user related data on the web server.

23. The computer implemented system of claim 14, wherein said web server further comprises a transaction module for performing transactions with the data sources in said online environment on receiving a transaction command from the user.

24. The computer implemented system of claim 14, wherein said web server further comprises a notification module for notifying the user if said retrieval of the user related data fails.

25. A computer program product comprising computer executable instructions embodied in a computer-readable medium, wherein said computer program product comprises:
a first computer parsable program code for generating an asymmetric key pair unique to a user, wherein said asymmetric key pair comprises said public key and a private key;
a second computer parsable program code for enabling said user to provide access credentials at a client device for each of a plurality of data sources;
a third computer parsable program code for transforming said access credentials to an unreadable format at said client device using said public key transmitted by a web server;
a fourth computer parsable program code for storing the transformed access credentials locally on the client device of the user;
a fifth computer parsable program code for communicating said stored access credentials to the web server;
a sixth computer parsable program code for transforming said communicated access credentials from said unreadable format to a readable format at the web server using said private key;
a seventh computer parsable program code for retrieving user related data from said data sources by accessing the data sources using the access credentials in said readable format; and
an eighth computer parsable program code for presenting said retrieved user related data to the user in one or more of a plurality of presentation modes in said online environment.
